(19) United States
(12) Patent Application Publication
(10) Pub. No.: US 2017/0318488 A1
(43) Pub. Date: Nov. 2, 2017

(54) MULTIPLEXING DEVICE AND METHOD

(71) Applicant: FUJITSU LIMITED, Kawasaki-shi (JP)

(72) Inventors: Akifumi Adachi, Kawasaki (JP); Tadanori YOKOSAWA, Yokosuka (JP); HIDEYUKI KANNARI, Yokohama (JP); Tadahiro Sato, Yokohama (JP)

(73) Assignee: FUJITSU LIMITED, Kawasaki-shi (JP)

(21) Appl. No.: 15/473,986

(22) Filed: Mar. 30, 2017

(30) Foreign Application Priority Data
Apr. 28, 2016 (JP) 2016-091017

(51) Int. Cl. H04W 24/08; H04W 72/04; H04W 72/08; H04L 12/26

(52) U.S. Cl. CPC H04W 24/08; H04W 72/085; H04L 43/16; H04W 72/0453; H04W 72/0473

(57) ABSTRACT

A multiplexing device for multiplexing uplink signals transmitted from each of a plurality of radio devices and outputting the multiplexed signal to a radio control device performs a calculation processing that calculates a power value of the uplink signal for each radio device, performs a determination processing that determines whether or not noise of a radio device that transmits an uplink signal is dominant among signal components included in the uplink signal, using the power value of the uplink signal, performs a blocking processing that blocks the uplink signal in which the noise is dominant in a case where the noise is determined to be dominant among the signal components included in the uplink signal, and performs a multiplexing processing that multiplexes uplink signals that are not blocked among the uplink signals for each radio device, and outputs the multiplexed signal to the radio control device.

### CROSS-REFERENCE TO RELATED APPLICATION

This application is based upon and claims the benefit of priority of the prior Japanese Patent Application No. 2016-091017, filed on Apr. 28, 2016, the entire contents of which are incorporated herein by reference.

### FIELD

The embodiments discussed herein are related to a multiplexing device and a method.

### BACKGROUND

A base station system is known in which one radio equipment controller (REC) and a plurality of radio equipment (RE) are coupled to each other via a cable such as an optical fiber. In such base station system, in a case where each RE transmits an uplink signal received from a mobile station to the REC, the uplink signal is compressed and transmitted to the REC in order to effectively utilize a capacity of the cable.

Examples of the related art include Japanese National Publication of International Patent Application No. 2015-510704.

### SUMMARY

According to an aspect of the invention, an A multiplexing device for multiplexing uplink signals transmitted from each of a plurality of radio devices and outputting the multiplexed signal to a radio control device includes: a memory; and a processor coupled to the memory and configured to perform a calculation processing that calculates a power value of the uplink signal for each radio device, perform a determination processing that determines whether or not noise of a radio device that transmits an uplink signal is dominant among signal components included in the uplink signal, using the power value of the uplink signal calculated by the calculation processing, perform a blocking processing that blocks the uplink signal in which the noise is dominant in a case where the noise is determined to be dominant among the signal components included in the uplink signal by the determination processing, and perform a multiplexing processing that multiplexes uplink signals that are not blocked by the blocking processing among the uplink signals for each radio device, and outputs the multiplexed signal to the radio control device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a base station system according to Embodiment 1;

FIG. 2 is a diagram illustrating an example of processing operation of a multiplexing device according to Embodiment 1;

FIG. 3 is a diagram illustrating an example of a base station system according to Embodiment 2;

FIG. 4 is a block diagram illustrating an example of a SW control unit according to Embodiment 2;

FIG. 5 is a diagram illustrating an example of processing operation of the SW control unit, a SW, and an uplink signal multiplexing unit in Embodiment 2;

FIG. 6 is a diagram illustrating an example of the processing operation of the SW control unit, the SW, and the uplink signal multiplexing unit in Embodiment 2;

FIG. 7 is a diagram illustrating an example of the processing operation of the SW control unit, the SW, and the uplink signal multiplexing unit in Embodiment 2;

FIG. 8 is a diagram illustrating an example of processing operation of a multiplexing device according to Embodiment 2;

FIG. 9 is a diagram illustrating an example of a base station system according to a modification example; and

FIG. 10 is a diagram illustrating an example of hardware of the multiplexing device.

### DESCRIPTION OF EMBODIMENTS

In order to more effectively utilize a capacity of a cable in a base station system, it is conceivable to provide, between a plurality of REs and a REC, a multiplexing device that multiplexes a plurality of uplink signals respectively transmitted from the plurality of REs, and outputs the multiplexed signals to the REC.

Here, the uplink signals transmitted from each RE may not include a user data signal from a mobile station in some cases. In this case, the uplink signal not including the user data signal may include the noise of each RE. Even in a case where the uplink signal transmitted from a certain RE includes only the noise, the above-described multiplexing device multiplexes the uplink signal including only the noise (hereinafter, referred to as a “noise signal”) and the uplink signal including a user data signal transmitted from another RE, and outputs the multiplexed signals to the REC. Therefore, a signal to noise ratio (SNR) of the uplink signal of the other RE which is output from the multiplexing device to the REC is degraded due to the multiplexing of the above-described “noise signal”. Here, the uplink signal including only the noise has an aspect of the signal having a noise component that is dominant among signal components included in the uplink signal.

As one aspect of the present embodiment, provided are solutions for being able to suppress degradation of the SNR of the uplink signal of each RE output from the multiplexing device to the REC.

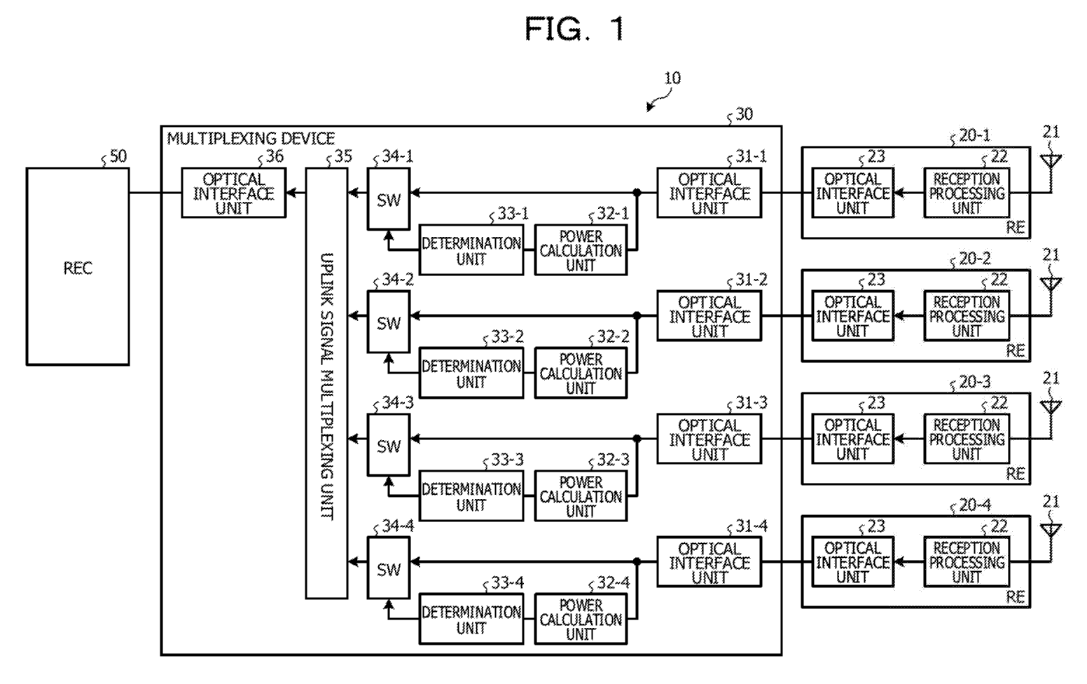

Hereinafter, embodiments of a multiplexing device disclosed in the present application are described in detail with reference to the drawings. A disclosed technology is not limited to the embodiments. In the embodiments, the same reference numerals are given to the components having the same function, and repeated descriptions are omitted.

<Base station system 10> FIG. 1 is a diagram illustrating an example of a base station system 10 according to Embodiment 1. In FIG. 1, the base station system 10 includes REs 20-1 to 20-4, a multiplexing device 30, and a REC 50. Each of the REs 20-1 to 20-4 and the multiplexing device 30 are coupled to each other via a cable such as an optical fiber. The multiplexing device 30 and the REC 50 are coupled to each other via a cable such as an optical fiber. The interface specifications between each of the REs 20-1 to 20-4 and the multiplexing device 30, or between the multiplexing device 30 and the REC 50 are standardized by Common Public Radio Interfaces (CPRI), for example. Hereinafter, in a case where the REs 20-1 to 20-4 are generally referred to without being discriminated from each other, each RE is referred to as RE 20. Each RE 20 is an example of a radio device. In the example of FIG. 1, although four REs 20 are coupled to the multiplexing device 30, the number of REs 20 is not limited to four.

The base station system 10 transmits and receives radio signal, for example, based on a wideband-code division multiple access (W-CDMA) system between the base station system 10 and a mobile station. For a downlink signal to be transmitted to the mobile station, the multiplexing device 30 of the embodiment copies the downlink signal, and transmits the downlink signal to each RE 20. Thereby, the same downlink signal is simultaneously transmitted from each RE 20. For the uplink signal transmitted from the mobile station, in a case where each RE 20 transmits the uplink signal received from the mobile station to the REC 50, the multiplexing device 30 of the embodiment multiplexes the uplink signal transmitted from each RE 20. The multiplexing device 30 outputs the multiplexed uplink signal to the REC 50 via a cable such as an optical fiber. The REC 50 is an example of a radio control device.

<RE 20> For example, as illustrated in FIG. 1, each RE 20 includes an antenna 21, a reception processing unit 22, and an optical interface unit 23. The reception processing unit 22 performs processes such as orthogonal modulation, down-conversion, and analog-to-digital conversion on the uplink signal received from the mobile station via the antenna 21, and outputs the processed uplink signal to the optical interface unit 23. The optical interface unit 23 maps the uplink signals output from the reception processing unit 22, onto an optical communication frame such as a CPRI frame, and outputs the mapped signals to the multiplexing device 30. Thereby, the uplink signal is transmitted from each RE 20 to the multiplexing device 30. Here, the uplink signal transmitted from each RE 20 may not include a user data signal from the mobile station in some cases. In this case, the uplink signal not including the user data signal includes only the noise (for example, thermal noise) of each RE 20. In other words, the uplink signal not including the user data signal has an aspect of the signal having a noise component that is dominant among signal components included in the uplink signal.

<Multiplexing device 30> For example, as illustrated in FIG. 1, the multiplexing device 30 includes optical interface units 31-1 to 31-4, power calculation units 32-1 to 32-4, determination units 33-1 to 33-4, SWs (switches) 34-1 to 34-4, an uplink signal multiplexing unit 35, and an optical interface unit 36. Hereinafter, in a case where the optical interface units 31-1 to 31-4 are generally referred to without being discriminated from each other, each optical interface unit is referred to as an optical interface unit 31. Hereinafter, in a case where the power calculation units 32-1 to 32-4 are generally referred to without being discriminated from each other, each power calculation unit is referred to as a power calculation unit 32. Hereinafter, in a case where the determination units 33-1 to 33-4 are generally referred to without being discriminated from each other, each determination unit is referred to as a determination unit 33. Hereinafter, in a case where the SWs 34-1 to 34-4 are generally referred to without being discriminated from each other, each SW is referred to as a SW 34. In the embodiment, one optical interface unit 31, one power calculation unit 32, one determination unit 33, and one SW 34 are provided for one RE 20.

The optical interface unit 31 receives the uplink signal (that is, optical communication frames) transmitted from the RE 20, converts the received uplink signal from an optical signal to an electric signal, and outputs the uplink signal converted into the electric signal to the SW 34. The optical interface unit 31 is an example of a receiving unit, and the uplink signal output from the optical interface unit 31 to the SW 34 is an example of the uplink signal received by the receiving unit.

The power calculation unit 32 calculates a power value of the uplink signal output from the optical interface unit 31 to the SW 34. The power calculation unit 32 outputs the calculated power value of the uplink signal to the determination unit 33. For example, the power calculation unit 32 may integrate or average power values of a plurality of uplink signals calculated in a predetermined period. Thereby, instantaneous fluctuation of the power value of the uplink signal is suppressed.

The determination unit 33 determines whether or not the uplink signal includes only the noise of the RE 20 that transmits the uplink signal, by using the power value of the uplink signal output from the power calculation unit 32. In other words, the determination unit 33 determines whether or not the noise component is dominant among the signal components included in the uplink signal, by using the power value of the uplink signal output from the power calculation unit 32. For example, in a case where the power value of the uplink signal exceeds a predetermined threshold Pth1, the determination unit 33 determines that the uplink signal includes not only the noise of the RE 20 but also the user data signal from the mobile station. On the other hand, in a case where the power value of the uplink signal is equal to or less than the threshold Pth1, the determination unit 33 determines that the uplink signal includes only the noise of the RE 20. The determination unit 33 outputs information representing whether or not the uplink signal includes only the noise of the RE 20 that transmits the uplink signal to the SW 34 as a determination result. The above-described threshold Pth1 is a value determined in advance based on a noise figure (NF) of the RE 20, and is, for example, an equivalent noise power value. The threshold Pth1 is an example of a first threshold.

In the above description, the threshold Pth1 is set to be a fixed value, but the threshold may be dynamically updated. For example, the determination unit 33 may acquire a plurality of power values of the uplink signal from the power calculation unit 32 in a predetermined period, and may update the threshold Pth1 with the smallest power value among the plurality of acquired power values. The threshold Pth1 may be different for each RE 20.

In accordance with the determination result received from the determination unit 33, the SW 34 switches passing/blocking of the uplink signal output from the optical interface unit 31 to the SW 34. Specifically, in a case where the determination unit 33 determines that the uplink signal includes not only the noise of the RE 20 but also the user data signal from the mobile station, the SW 34 passes the uplink signal output from the optical interface unit 31 to the SW 34, and outputs the uplink signal to the uplink signal multiplexing unit 35. On the other hand, in a case where the determination unit 33 determines that the uplink signal includes only the noise of the RE 20, the SW 34 blocks the uplink signal output from the optical interface unit 31 to the SW 34, that is, the uplink signal including only the noise of the RE 20 (hereinafter, referred to as “noise signal”).

The uplink signal multiplexing unit 35 multiplexes the uplink signals output from the optical interface units 31 to the SWs 34, and not blocked as the noise signals by the SWs 34. The uplink signal multiplexing unit 35 outputs the multiplexed uplink signal to the REC 50. Thereby, the noise signal is excluded from the uplink signal of each RE 20 output from the multiplexing device 30 to the REC 50. As a result, it is possible to suppress the degradation of the SNR of the uplink signal of each RE 20 output from the multiplexing device 30 to the REC 50.

Here, it is assumed that the uplink signal transmitted from the RE 20-1 is a noise signal, and the uplink signal transmitted from each of the RE 20-2 to RE 20-4 includes the user data signal from the mobile station. In this case, although the uplink signal transmitted from the RE 20-1 is blocked as a noise signal by the SW 34-1, since the uplink signal transmitted from each of the RE 20-2 to RE 20-4 includes the user data signal, the uplink signal is not blocked by the SW 34-2 to SW 34-4. Therefore, the uplink signal multiplexing unit 35 multiplexes the uplink signals from the RE 20-2 to RE 20-4 not blocked as the noise signals by the SW 34-2 to SW 34-4, and outputs the multiplexed signals to the REC 50. At this time, the noise signal which is the noise signal from RE 20-1 is not multiplexed in the uplink signals from the RE 20-2 to RE 20-4. Accordingly, the degradation of the SNR of the uplink signal from each of the RE 20-2 to RE 20-4 is suppressed.

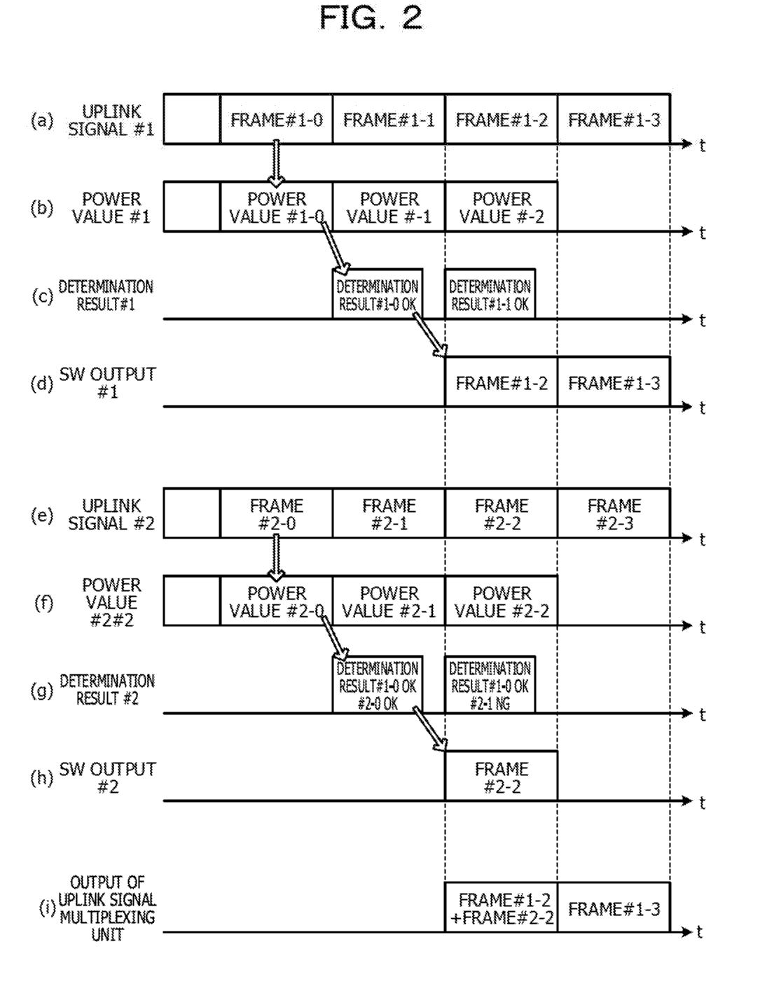

The optical interface unit 36 maps the uplink signal which is output from the uplink signal multiplexing unit 35 to the REC 50, onto the optical communication frame, and transmits the mapped uplink signal to the REC 50.

<Operation of multiplexing device 30> An example of processing operation of the multiplexing device 30 having the above-described configuration is described. FIG. 2 is a diagram illustrating an example of the processing operation of the multiplexing device 30 according to Embodiment 1. In FIG. 2, it is assumed that the two REs 20-1 and RE 20-2 are coupled to the multiplexing device 30. In FIG. 2, an uplink signal #1 is the uplink signal transmitted from the RE 20-1, and is set to be divided into a plurality of frames (frame #1-0 to frame #1-3) along the time axis. An uplink signal #2 is the uplink signal transmitted from the RE 20-2, and is set to be divided into a plurality of frames (frame #2-0 to frame #2-3) along the time axis.

First, the processing operation of the multiplexing device 30 in a case where both of the uplink signal transmitted from the RE 20-1 and the uplink signal transmitted from the RE 20-2 include the user data signal from the mobile station, is described.

For example, as illustrated in (a) of FIG. 2, when the frame #1-0 of the uplink signal transmitted from the RE 20-1 is received by the optical interface unit 31-1 of the multiplexing device 30, as illustrated in (b) of FIG. 2, the power calculation unit 32-1 calculates the power value #1-0 of the frame #1-0.

As illustrated in (c) of FIG. 2, the determination unit 33-1 determines whether or not the uplink signal transmitted from the RE 20-1 includes only the noise of the RE 20-1 by using the power value #1-0 of the frame #1-0, and outputs the determination result #1-0 thereof to the SW 34-1. In the example of (c) of FIG. 2, the determination result #1-0 is “OK”, and illustrates that the uplink signal transmitted from the RE 20-1 includes not only the noise of the RE 20-1 but also the user data signal from the mobile station.

As illustrated in (d) of FIG. 2, the SW 34-1 switches the passing/blocking of the frame #1-2 according to the determination result #1-0 received from the determination unit 33-1. In the example of (d) of FIG. 2, the determination result #1-0 is “OK”, and illustrates that the uplink signal transmitted from the RE 20-1 includes not only the noise of the RE 20-1 but also the user data signal from the mobile station. Therefore, the SW 34-1 passes the frame #1-2, and outputs the frame to the uplink signal multiplexing unit 35.

On the other hand, as illustrated in (e) of FIG. 2, when the frame #2-0 of the uplink signal transmitted from the RE 20-2 is received by the optical interface unit 31-2 of the multiplexing device 30, as illustrated in (f) of FIG. 2, the power calculation unit 32-2 calculates the power value #2-0 of the frame #2-0.

As illustrated in (g) of FIG. 2, the determination unit 33-2 determines whether or not the uplink signal transmitted from the RE 20-2 includes only the noise of the RE 20-2 by using the power value #2-0 of the frame #2-0, and outputs the determination result #2-0 thereof to the SW 34-2. In the example of (g) of FIG. 2, the determination result #2-0 is “OK”, and illustrates that the uplink signal transmitted from the RE 20-2 includes not only the noise of the RE 20-2 but also the user data signal from the mobile station.

As illustrated in (h) of FIG. 2, the SW 34-2 switches the passing/blocking of the frame #2-2 according to the determination result #2-0 received from the determination unit 33-2. In the example of (h) of FIG. 2, the determination result #2-0 is “OK”, and illustrates that the uplink signal transmitted from the RE 20-2 includes not only the noise of the RE 20-2 but also the user data signal from the mobile station. Therefore, as illustrated in (h) of FIG. 2, the SW 34-2 passes the frame #2-2, and outputs the frame to the uplink signal multiplexing unit 35.

The uplink signal multiplexing unit 35 multiplexes the frame #1-2 output from the SW 34-1 and the frame #2-2 output from the SW 34-2, and outputs the multiplexed frame to the REC 50.

Subsequently, the processing operation of the multiplexing device 30 in a case where the uplink signal transmitted from the RE 20-1 includes the user data signal from the mobile station, and the uplink signal transmitted from the RE 20-2 includes only the noise of the RE 20-2 is described.

For example, as illustrated in (a) of FIG. 2, when the frame #1-1 of the uplink signal transmitted from the RE 20-1 is received by the optical interface unit 31-1 of the multiplexing device 30, as illustrated in (b) of FIG. 2, the power calculation unit 32-1 calculates the power value #1-1 of the frame #1-1.

As illustrated in (c) of FIG. 2, the determination unit 33-1 determines whether or not the uplink signal transmitted from the RE 20-1 includes only the noise of the RE 20-1 by using the power value #1-1 of the frame #1-1, and outputs the determination result #1-1 thereof to the SW 34-1. In the example of (c) of FIG. 2, the determination result #1-1 is “OK”, and illustrates that the uplink signal transmitted from the RE 20-1 includes not only the noise of the RE 20-1 but also the user data signal from the mobile station.

As illustrated in (d) of FIG. 2, the SW 34-1 switches the passing/blocking of the frame #1-3 according to the determination result #1-1 received from the determination unit 33-1. In the example of (d) of FIG. 2, the determination result #1-1 is “OK”, and illustrates that the uplink signal transmitted from the RE 20-1 includes not only the noise of the RE 20-1 but also the user data signal from the mobile station. Therefore, the SW 34-1 passes the frame #1-3, and outputs the frame to the uplink signal multiplexing unit 35.

On the other hand, as illustrated in (e) of FIG. 2, when the frame #2-1 of the uplink signal transmitted from the RE 20-2 is received by the optical interface unit 31-2 of the multiplexing device 30, as illustrated in (f) of FIG. 2, the power calculation unit 32-2 calculates the power value #2-1 of the frame #2-1.

As illustrated in (g) of FIG. 2, the determination unit 33-2 determines whether or not the uplink signal transmitted from the RE 20-2 includes only the noise of the RE 20-2 by using the power value #2-1 of the frame #2-1, and outputs the determination result #2-1 thereof to the SW 34-2. In the example of (g) of FIG. 2, the determination result #2-1 is “NG”, and illustrates that the uplink signal transmitted from the RE 20-2 includes only the noise of the RE 20-2.

As illustrated in (h) of FIG. 2, the SW 34-2 switches the passing/blocking of the frame #2-3 according to the determination result #2-1 received from the determination unit 33-2. In the example of (h) of FIG. 2, the determination result #2-1 is “NG”, and illustrates that the uplink signal transmitted from the RE 20-2 includes only the noise of the RE 20-2. Therefore, as illustrated in (h) of FIG. 2, the SW 34-2 blocks the frame #2-3, and does not output the frame to the uplink signal multiplexing unit 35.

As illustrated in (i) of FIG. 2, the uplink signal multiplexing unit 35 outputs only the frame #1-3 to the REC 50, without multiplexing the frame #1-3 output from the SW 34-1 to the frame #2-3.

According to the embodiment described above, the multiplexing device 30 includes the optical interface unit 31, the power calculation unit 32, the determination unit 33, the SW 34, and the uplink signal multiplexing unit 35. The optical interface unit 31 is provided for each RE 20, and receives the uplink signal transmitted from the RE 20. The power calculation unit 32 calculates the power value of the uplink signal received by the optical interface unit 31. The determination unit 33 determines whether or not the uplink signal includes only the noise of the RE 20 that transmits the uplink signal, by using the power value of the uplink signal calculated by the power calculation unit 32. In a case where the determination unit 33 determines that the uplink signal includes only the noise, the SW 34 blocks the noise signal. The uplink signal multiplexing unit 35 multiplexes the uplink signals received by the optical interface units 31 and not blocked as the noise signals by the SWs 34, and outputs the multiplexed signal to the REC 50.

By the configuration of the multiplexing device 30, the noise signal is excluded from the uplink signal of each RE 20 output from the multiplexing device 30 to the REC 50. As a result, it is possible to suppress the degradation of the SNR of the uplink signal of each RE 20 output from the multiplexing device 30 to the REC 50.

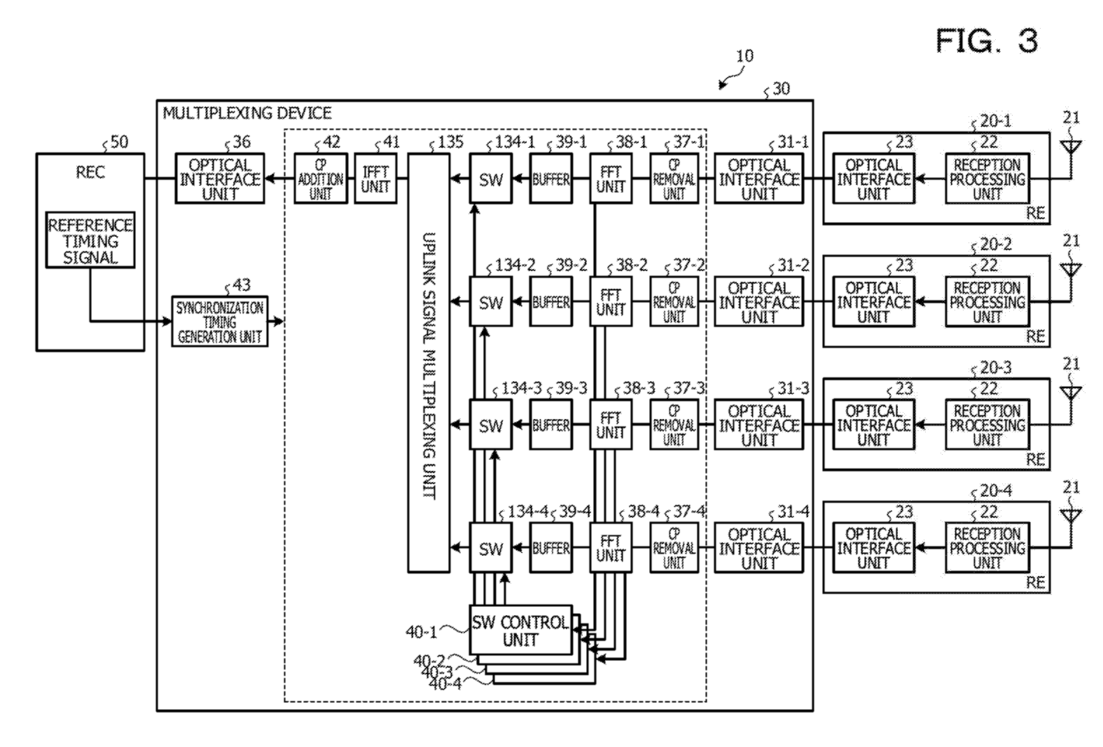

Embodiment 2 is different from Embodiment 1 in that the uplink signal is a signal of a single carrier frequency division multiple access (SC-FDMA) system, and a frequency resource unit including only the noise is blocked.

<Base station system 10> FIG. 3 is a diagram illustrating an example of a base station system 10 according to Embodiment 2. In FIG. 3, the base station system 10 includes the REs 20-1 to 20-4, the multiplexing device 30, and the REC 50. Except for the points described below, in FIG. 3, since blocks denoted by the same reference numerals as those in FIG. 1 have the same or similar functions as the blocks in FIG. 1, repeated descriptions are omitted.

<Multiplexing device 30> As illustrated in FIG. 3, the multiplexing device 30 includes optical interface units 31-1 to 31-4, cyclic prefix (CP) removal units 37-1 to 37-4, and fast fourier transform (FFT) units 38-1 to 38-4. The multiplexing device 30 includes buffers 39-1 to 39-4, SW control units 40-1 to 40-4, SWs 134-1 to 134-4, and an uplink signal multiplexing unit 135. The multiplexing device 30 includes an inverse fast fourier transform (IFFT) unit 41, a CP addition unit 42, a synchronization timing generation unit 43, and an optical interface unit 36.

Hereinafter, in a case where the CP removal units 37-1 to 37-4 are generally referred to without being discriminated from each other, the CP removal units are referred to as a CP removal unit 37. Hereinafter, in a case where the FFT units 38-1 to 38-4 are generally referred to without being discriminated from each other, the FFT units are referred to as an FFT unit 38. Hereinafter, in a case where buffers 39-1 to 39-4 are generally referred to without being discriminated each other, the buffers are referred to as a buffer 39. Hereinafter, in a case where the SW control units 40-1 to 40-4 are generally referred to without being discriminated from each other, the SW control units are referred to as a SW control unit 40. Hereinafter, in a case where the SWs 134-1 to 134-4 are generally referred to without being discriminated from each other, the SWs are referred to as a SW 134. In the embodiment, one CP removal unit 37, one FFT unit 38, one buffer 39, one SW control unit 40, and one SW 134 are provided for one RE 20.

The optical interface unit 31 receives the uplink signal (that is, optical communication frame) transmitted from the RE 20, converts the received uplink signal from an optical signal to an electric signal, and outputs the uplink signal converted into the electric signal to the SW 134. Here, the uplink signal transmitted from the RE 20 is a signal of the SC-FDMA system. The optical interface unit 31 is an example of the receiving unit, and the uplink signal output from the optical interface unit 31 to the SW 134 is an example of the uplink signal received by the receiving unit.

The CP removal unit 37 removes the CP from the uplink signal output from the optical interface unit 31 to the SW 134, and outputs the uplink signal whose CP is removed to the FFT unit 38.

The FFT unit 38 converts the uplink signal (that is, signal in a time domain) output from the CP removal unit 37, into a plurality of frequency components that are continuous in a frequency domain. The FFT unit 38 stores the converted plurality of frequency components in the buffer 39, and outputs the frequency components to the SW control unit 40. The FFT unit 38 is an example of a conversion unit.

The buffer 39 outputs the plurality of frequency components to the SW 134 at synchronization timing which is described later and output from the synchronization timing generation unit 43.

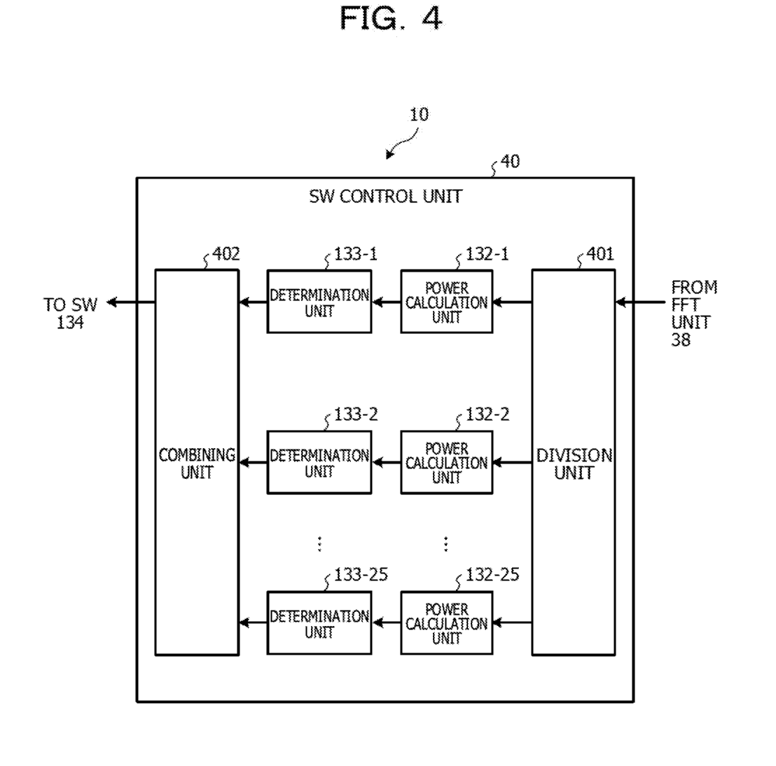

For example, as illustrated in FIG. 4, the SW control unit 40 includes a division unit 401, power calculation units 132-1 to 132-25, determination units 133-1 to 133-25, and a combining unit 402. FIG. 4 is a block diagram illustrating an example of the SW control unit 40 according to Embodiment 2. Hereinafter, in a case where the power calculation units 132-1 to 132-25 are generally referred to without being discriminated from each other, the power calculation units are referred to as a power calculation unit 132. Hereinafter, in a case where the determination units 133-1 to 133-25 are generally referred to without being discriminated from each other, the determination units are referred to as a determination unit 133.

The division unit 401 divides the plurality of frequency components output from the FFT unit 38 by a predetermined number, and respectively distributes the plurality of frequency resource units obtained by the division to the power calculation units 132-1 to 132-25.

In the SC-FDMA system of the 3rd generation partnership project Long Term Evolution (3GPP LTE), for example, 12 adjacent subcarriers (frequency components), for example, at an interval of 15 kHz are defined as one resource block (RB). In the SC-FDMA system of the 3GPP LTE, uplink signal communication is performed using, for example, 300 subcarriers (frequency components) included in the 5 MHz bandwidth. That is, in a case where the uplink signal communication is performed using 300 subcarriers (frequency components) included in the 5 MHz bandwidth, the 5 MHz bandwidth includes 300/12=25 RBs. In the following description, the division unit 401 divides the 300 frequency components which are output from the FFT unit 38, into resource blocks each including 12 frequency components, and supplies the obtained 25 RBs (RB #0 to RB #24) to the power calculation units 132-1 to 132-25, respectively. The RB is an example of the frequency resource unit.

The power calculation unit 132 calculates the power value of the RB distributed by the division unit 401. For example, the power calculation unit 132 calculates the power values of 12 subcarriers included in the RB distributed by the division unit 401, and calculates the integrated value or the average value of the obtained 12 power values as the power value of the RB. The power calculation unit 132 outputs the calculated power value of the RB to the determination unit 133.

The determination unit 133 determines whether or not the RB includes only the noise of the RE 20 that transmits the RB, by using the power value of the RB output from the power calculation unit 132. Specifically, in a case where the power value of the RB exceeds a predetermined threshold Pth2, the determination unit 133 determines that the RB includes not only the noise of the RE 20 but also the user data signal from the mobile station. On the other hand, in a case where the power value of the RB is equal to or less than the threshold Pth2, the determination unit 133 determines that the RB includes only the noise of the RE 20. The determination unit 133 outputs information indicating whether or not the RB includes only the noise of the RE 20 that transmits the RB to the combining unit 402 as a determination result. The above-described threshold Pth2 is a value determined in advance based on a noise figure (NF) of the RE 20, and is, for example, an equivalent noise power value. The threshold Pth2 is an example of a second threshold.

The threshold Pth2 may be different for each RE 20. For example, the higher the priority of the RE 20, the lower the threshold Pth2 may be. Thereby, the probability that the RB of the uplink signal transmitted from the RE 20 with a higher priority is determined to include the user data signal is improved.

The combining unit 402 combines the determination results of the determination units 133, and outputs the combined determination result of the determination units 133 to the SW 134.

FIG. 3 is referred to again. In accordance with the determination result of the determination unit 133 received from the combining unit 402, the SW 134 switches the passing/blocking of the plurality of frequency components output from the buffer 39 for each RB. Specifically, in a case where the determination unit 133 determines that the RB includes not only the noise of the RE 20 but also the user data signal from the mobile station, the SW 134 passes the RB output from the buffer 39, and outputs the RB to the uplink signal multiplexing unit 135. On the other hand, in a case where the determination unit 133 determines that the RB includes only the noise of the RE 20, the SW 134 blocks the RB that is output from the buffer 39, and that includes only the noise of the RE 20 (hereinafter, referred to as “noise RB”). For example, the amplitude value of each frequency component belonging to the noise RB is forcibly changed to zero, and thereby the SW 134 blocks the noise RB. The noise RB is an example of a noise resource unit.

The uplink signal multiplexing unit 135 multiplexes the frequency components belonging to the RBs not blocked as the noise RB by the SW 134, among the plurality of frequency components output from the buffers 39. The uplink signal multiplexing unit 135 outputs the multiplexed frequency component to the REC 50. Thereby, it is possible to suppress for each RB the degradation of the SNR of the uplink signal of each RE 20 output from the multiplexing device 30 to the REC 50.

The IFFT unit 41 converts the frequency component output from the uplink signal multiplexing unit 135 to the REC 50, into the uplink signal in the time domain.

The CP addition unit 42 adds the CP to the uplink signal in the time domain obtained by the IFFT unit 41, and outputs the uplink signal to which the CP is added to the optical interface unit 36.

The optical interface unit 36 maps the uplink signal output from the CP addition unit 42, onto the optical communication frame, and transmits the mapped uplink signal to the REC 50.

The synchronization timing generation unit 43 acquires a reference timing signal serving as a reference for synchronization between the REC 50 and each RE 20 from the REC 50, and generates synchronization timing based on the acquired reference timing signal. For example, in a case where the output timing of the reference timing signal is one second cycle, the synchronization timing is a cycle of one to ten msec. The synchronization timing generation unit 43 outputs the generated synchronization timing to the CP removal unit 37, the FFT unit 38, the buffer 39, the SW control unit 40, SW 134, the uplink signal multiplexing unit 135, the IFFT unit 41, and the CP addition unit 42. The synchronization timing is used in synchronization with the processing timing of these processing units.

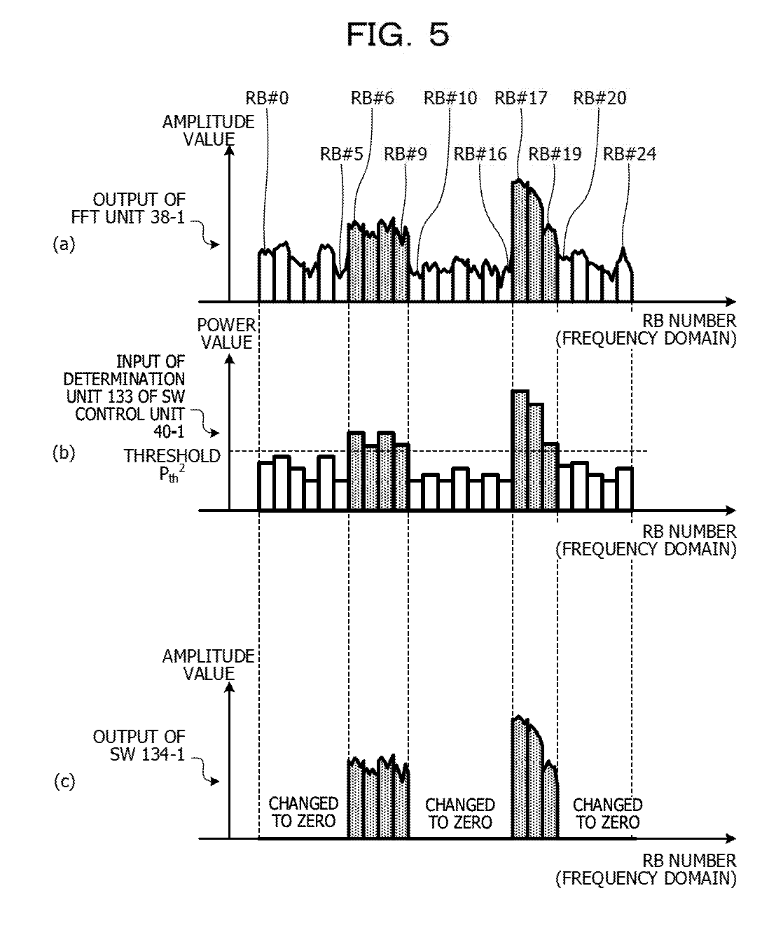

In the above-described description, although the reference timing signal of the REC 50 is used in generation of the synchronization timing, a public radio signal such as a global positioning system (GPS) signal may be used instead of the reference timing signal.

<Operation of SW control unit 40, SW 134, and uplink signal multiplexing unit 135> FIGS. 5 to 7 are diagrams illustrating an example of processing operation of the SW control unit 40, a SW 134, and an uplink signal multiplexing unit 135 in Embodiment 2. In FIGS. 5 to 7, it is assumed that two RE 20-1 and RE 20-2 are coupled to the multiplexing device 30.

When 300 frequency components are output from the FFT unit 38-1, the division unit 401 of the SW control unit 40-1 divides 300 frequency components into resource blocks each including 12 frequency components as illustrated in (a) of FIG. 5, and acquires 25 RBs (RB #0 to RB #24). The division unit 401 of the SW control unit 40-1 respectively distributes the obtained 25 RBs (RB #0 to RB #24) to the power calculation units 132-1 to 132-25.

The power calculation units 132-1 to 132-25 respectively calculate the power values of the RB #0 to RB #24. As illustrated in (b) of FIG. 5, the calculated power values of the RB #0 to RB #24 are input to the determination units 133-1 to 133-25.

The determination units 133-1 to 133-25 respectively determine whether or not the RB #0 to RB #24 include only the noise of RE 20-1, by using the power values of the RB #0 to RB #24. That is, in a case where the power values of the RB #0 to RB #24 are equal to or less than the threshold Pth2, the determination units 133-1 to 133-25 determine that the RBs include only the noise of the RE 20-1. In the example of (b) of FIG. 5, since the power values of the RB #0 to RB #5, the RB #10 to RB #16, and the RB #20 to RB #24 are equal to or lower than the threshold Pth2, it is determined that the RB #0 to RB #5, the RB #10 to RB #16, and the RB #20 to RB #24 include only the noise of the RE 20-1.

Since it is determined that the RB #0 to RB #5, the RB #10 to RB #16, and the RB #20 to RB #24 include only the noise of the RE 20-1, the SW 134-1 blocks the RB #0 to RB #5, the RB #10 to RB #16, and the RB #20 to RB #24 as the noise RBs. That is, as illustrated in (c) of FIG. 5, the amplitude value of each frequency component belonging to the RB #0 to RB #5, the RB #10 to RB #16, and the RB #20 to RB #24 is forcibly changed to zero, and thereby the SW 134-1 blocks the noise RB.

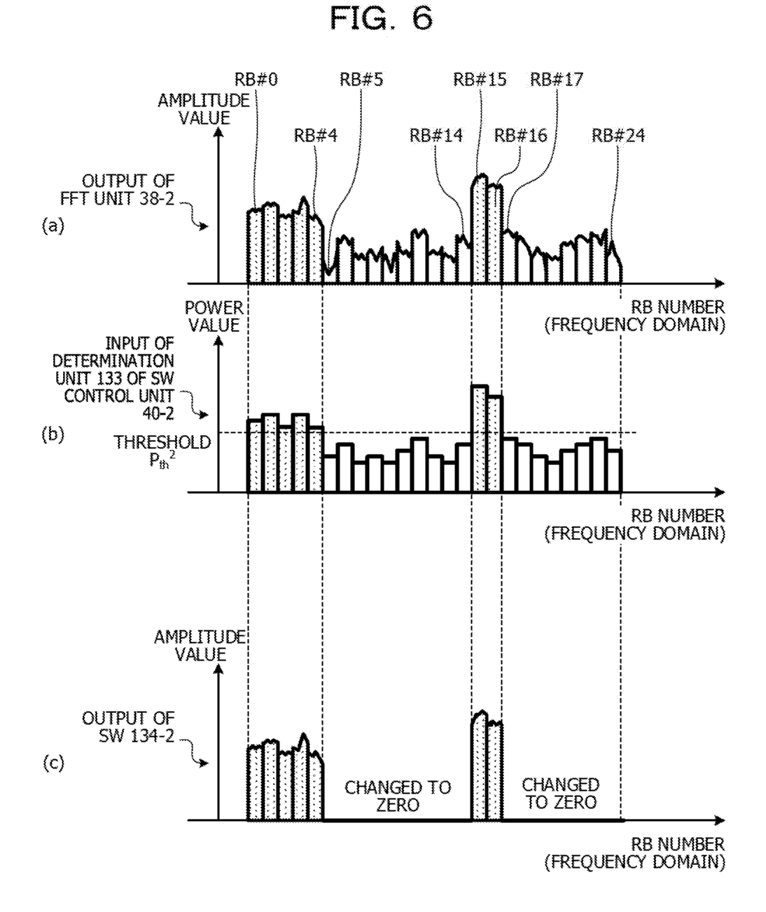

On the other hand, when 300 frequency components are output from the FFT unit 38-2, the division unit 401 of the SW control unit 40-2 divides 300 frequency components into resource blocks each having 12 frequency components as illustrated in (a) of FIG. 6, and acquires 25 RBs (RB #0 to RB #24). The division unit 401 of the SW control unit 40-2 respectively distributes the acquired 25 RBs (RB #0 to RB #24) to the power calculation units 132-1 to 132-25.

The power calculation units 132-1 to 132-25 respectively calculate the power values of the RB #0 to RB #24. As illustrated in (b) of FIG. 6, the calculated power values of the RB #0 to RB #24 are input to the determination units 133-1 to 133-25.

The determination units 133-1 to 133-25 respectively determine whether or not the RB #0 to RB #24 include only the noise of the RE 20-2, by using the power values of the RB #0 to RB #24. That is, in a case where the power values of the RB #0 to RB #24 are equal to or less than the threshold Pth2, the determination units 133-1 to 133-25 determine that the RB includes only the noise of the RE 20-2. In the example of (b) of FIG. 6, since the power values of the RB #5 to RB #14 and the RB #17 to RB #24 are equal to or less than the threshold Pth2, it is determined that the RB #5 to RB #14 and the RB #17 to RB #24 include only the noise of the RE 20-2.

Since it is determined that the RB #5 to RB #14 and the RB #17 to RB #24 include only the noise of the RE 20-2, the SW 134-2 blocks the RB #5 to RB #14 and the RB #17 to RB #24 as the noise RBs. That is, as illustrated in (c) of FIG. 6, the amplitude value of each frequency component belonging to the RB #5 to RB #14 and the RB #17 to RB #24 is forcibly changed to zero, and thereby the SW 134-2 blocks the noise RB.

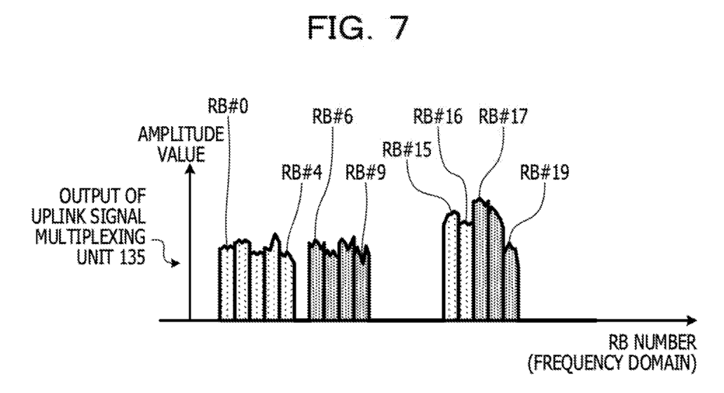

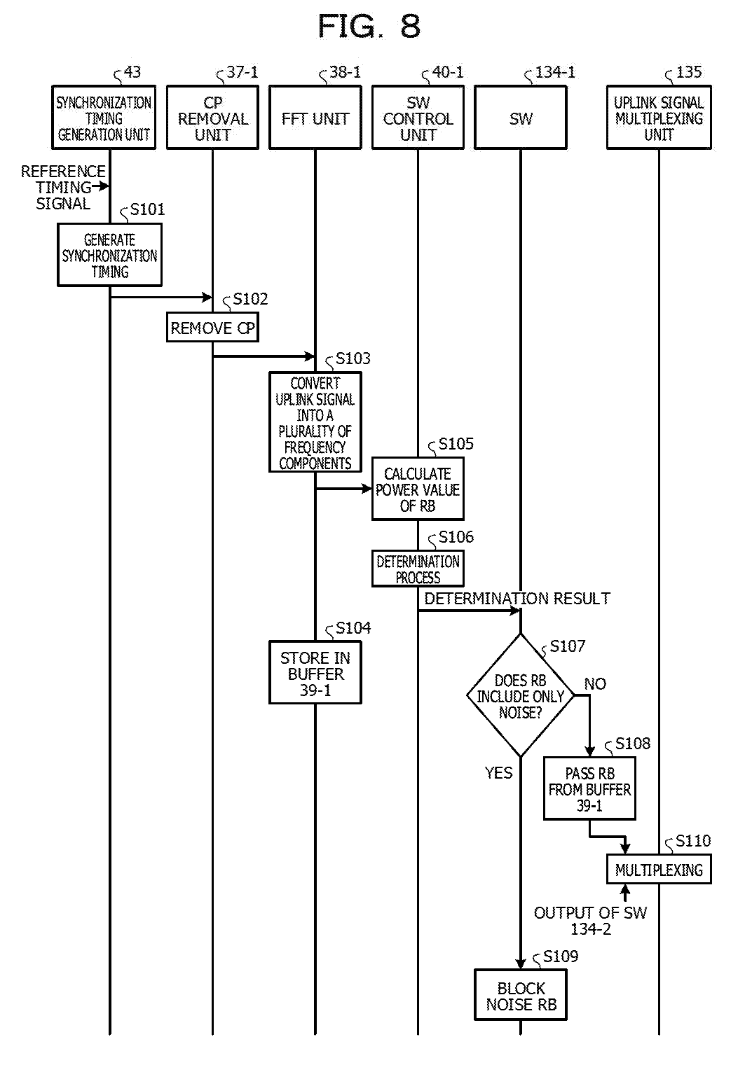

As illustrated in FIG. 7, the uplink signal multiplexing unit 135 multiplexes the frequency components belonging to the RBs (RB #0 to RB #4, RB #6 to RB #9, RB #15, RB #16, and RB #17 to RB #19) not blocked as the noise RBs by the SW 134-1 and SW 134-2. The uplink signal multiplexing unit 135 outputs the multiplexed frequency component to the REC 50.

<Operation of the multiplexing device 30> An example of processing operation of the multiplexing device 30 having the above-described configuration is described. FIG. 8 is a diagram illustrating an example of processing operation of a multiplexing device 30 according to Embodiment 2. In FIG. 8, it is assumed that two RE 20-1 and RE 20-2 are coupled to the multiplexing device 30.

The synchronization timing generation unit 43 acquires from the REC 50 a reference timing signal serving as a reference for synchronization between the REC 50 and each RE 20, and generates synchronization timing based on the acquired reference timing signal (Step S101). The synchronization timing generation unit 43 outputs the generated synchronization timing to the CP removal unit 37, the FFT unit 38, the buffer 39, the SW control unit 40, the SW 134, the uplink signal multiplexing unit 135, the IFFT unit 41, and the CP addition unit 42. The synchronization timing is used in synchronization with the processing timing of these processing units.

The CP removal unit 37-1 removes the CP from the uplink signal which is output from the optical interface unit 31-1 to the SW 134-1, and outputs the uplink signal whose CP is removed to the FFT unit 38-1 (Step S102).

The FFT unit 38-1 converts the uplink signal (that is, signal in a time domain) output from the CP removal unit 37-1, into a plurality of frequency components that are continuous in a frequency domain. The FFT unit 38-1 stores the converted plurality of frequency components in the buffer 39-1, and outputs the frequency components to the SW control unit 40-1 (Step S103 and Step S104).

The power calculation unit 132 of the SW control unit 40-1 calculates the power value of the RB (Step S105). The determination unit 133 of the SW control unit 40-1 determines whether or not the RB includes only the noise of the RE 20-1 that transmits the RB by using the power value of the RB, and outputs the determination result to the SW 134-1 via the combining unit 402 (Step S106).

In a case where the determination unit 133 determines that the RB includes not only the noise of the RE 20-1 but also the user data signal from the mobile station (No in Step S107), the SW 134-1 passes the RB output from the buffer 39-1, and outputs the RB to the uplink signal multiplexing unit 135 (Step S108). On the other hand, in a case where the determination unit 133 determines that the RB includes only the noise of the RE 20 (Yes in Step S107), the SW 134-1 blocks the noise RB that is output from the buffer 39-1 and that includes only the noise of the RE 20-1 (Step S109).

The uplink signal multiplexing unit 135 multiplexes the frequency component belonging to the RB not blocked as the noise RB by the SW 134-1 and the frequency component output from the SW 134-2, among the plurality of frequency components output from the buffer 39-1 (Step 5110). The frequency component multiplexed by the uplink signal multiplexing unit 135 is converted by the IFFT unit 41 into the uplink signal in the time domain, and is output to the REC 50 via the optical interface unit 36 after the CP is added by the CP addition unit 42.

According to the embodiment described above, the multiplexing device 30 includes the FFT unit 38 that converts the uplink signal received by the optical interface unit 31 into the plurality of frequency components that are continuous in the frequency domain. In the multiplexing device 30, the power calculation unit 132 calculates the power of a frequency resource unit (that is, RB) obtained by dividing a plurality of frequency components by a predetermined number. The determination unit 133 determines whether or not the RB includes only the noise of the RE 20, by using the power value of the RB. In a case where the determination unit 133 determines that the RB includes only the noise, the SW 134 blocks the noise RB. The uplink signal multiplexing unit 135 multiplexes the frequency component belonging to the RB not blocked as the noise RB by the SW 134 among the plurality of frequency components, and outputs the multiplexed component to the REC 50.

By the configuration of the multiplexing device 30, the noise RB is excluded from the uplink signals of each RE 20 output from the multiplexing device 30 to the REC 50. As a result, it is possible to suppress for each RB the degradation of the SNR of the uplink signal of each RE 20 output from the multiplexing device 30 to the REC 50.

<Other embodiments> The disclosed technology is not limited to the above-described embodiments, and various modifications are possible within the scope of the gist thereof.

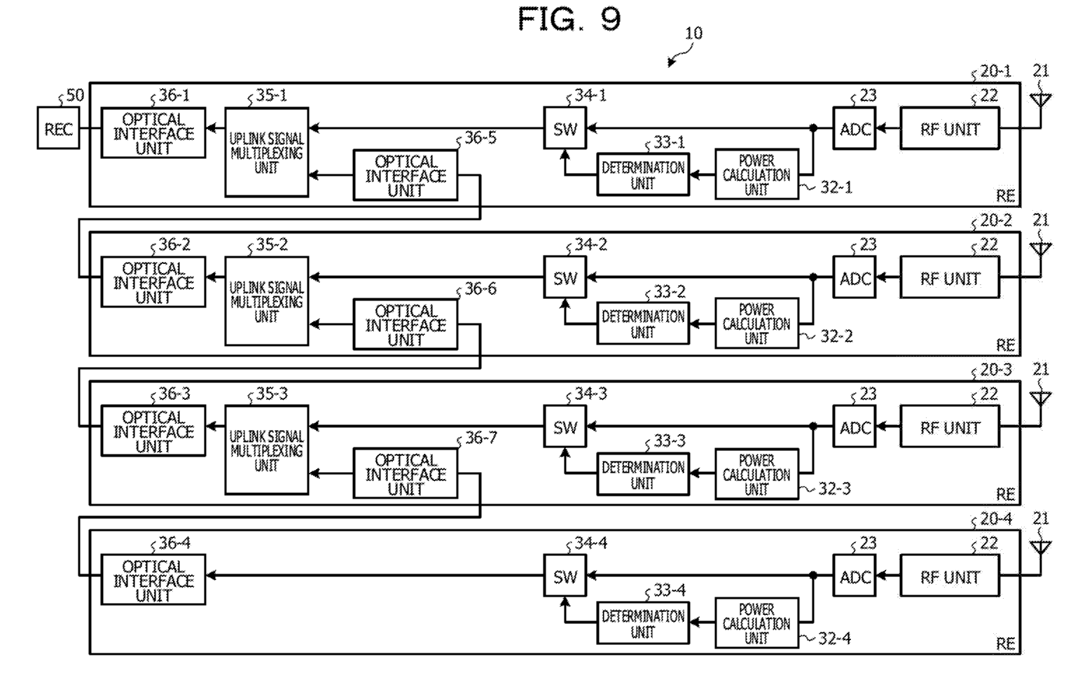

For example, in the above-described Embodiment 1, although the base station system 10 includes the REs 20-1 to 20-4, the multiplexing device 30, and the REC 50, the disclosed technology is not limited thereto. For example, the REs 20-1 to 20-4 and the multiplexing device 30 may be configured as an integrated device. The base station system 10 in which the REs 20-1 to 20-4 and the multiplexing device 30 are configured as the integrated device is illustrated in FIG. 9 as the base station system 10 according to a modification example. FIG. 9 is a diagram illustrating an example of the base station system 10 according to the modification example.

In FIG. 9, the base station system 10 according to the modification example includes REs 20-1 to 20-4 and a REC 50. Except the points described below, in FIG. 9, since blocks denoted by the same reference numerals as those in FIG. 1 have the same or similar functions as the blocks in FIG. 1, repeated descriptions are omitted.

The power calculation unit 32, the determination unit 33, and the SW 34 of the multiplexing device 30 in FIG. 1 are incorporated in the REs 20-1 to 20-4. The uplink signal multiplexing unit 35 of the multiplexing device 30 in FIG. 1 is incorporated as the uplink signal multiplexing units 35-1 to 35-3 in the REs 20-1 to 20-3. The REs 20-1 to 20-4 are cascade-coupled by using the optical interface units 36-1 to 36-7.

The multiplexing devices 30 of the above-described Embodiment 1 and Embodiment 2, for example, can be realized by the following hardware configuration.

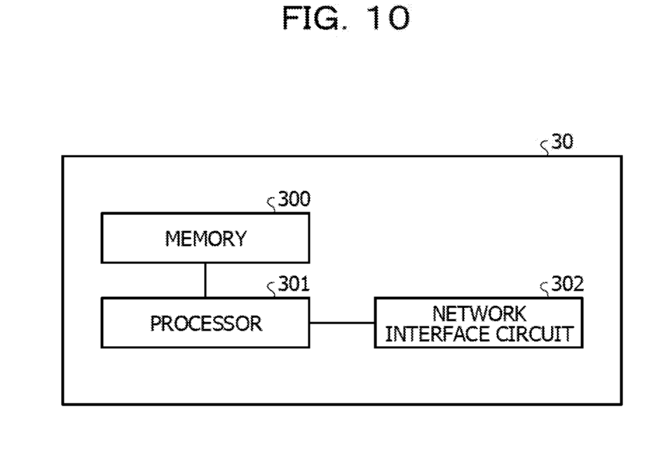

FIG. 10 is a diagram illustrating an example of hardware of the multiplexing device 30. For example, as illustrated in FIG. 10, the multiplexing device 30 includes a memory 300, a processor 301, and a network interface circuit 302.

The network interface circuit 302 transmits and receives communication data between each RE 20 and the REC 50. The optical interface units 31 and 36 are realized by the network interface circuit 302. In Embodiment 1, the memory 300 stores various programs such as a program for realizing functions of the power calculation unit 32, the determination unit 33, the SW 34, and the uplink signal multiplexing unit 35. The processor 301 executes the program read from the memory 300, and cooperates with the network interface circuit 302 or the like. Thereby, in Embodiment 1, the processor 301 realizes the functions of the power calculation unit 32, the determination unit 33, the SW 34, and the uplink signal multiplexing unit 35.

In Embodiment 2, the memory 300 stores various programs such as a program for realizing functions of the CP removal unit 37, the FFT unit 38, the buffer 39, the SW control unit 40, the SW 134, the uplink signal multiplexing unit 135, the IFFT unit 41, the CP addition unit 42, and the synchronization timing generation unit 43. In Embodiment 2, the processor 301 executes the program read from the memory 300, and cooperates with the network interface circuit 302 or the like. Thereby, in Embodiment 2, the processor 301 realizes the functions of the CP removal unit 37, the FFT unit 38, the buffer 39, the SW control unit 40, the SW 134, the uplink signal multiplexing unit 135, the IFFT unit 41, the CP addition unit 42, and the synchronization timing generation unit 43.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A multiplexing device for multiplexing uplink signals transmitted from each of a plurality of radio devices and outputting the multiplexed signal to a radio control device, the multiplexing device comprising:
a memory; and
a processor coupled to the memory and configured to
perform a calculation processing that calculates a power value of the uplink signal for each radio device,
perform a determination processing that determines whether or not noise of a radio device that transmits an uplink signal is dominant among signal components included in the uplink signal, using the power value of the uplink signal calculated by the calculation processing,
perform a blocking processing that blocks the uplink signal in which the noise is dominant in a case where the noise is determined to be dominant among the signal components included in the uplink signal by the determination processing, and
perform a multiplexing processing that multiplexes uplink signals that are not blocked by the blocking processing among the uplink signals for each radio device, and outputs the multiplexed signal to the radio control device.

2. The multiplexing device according to claim 1,
wherein the determination processing includes determining that the uplink signal includes only the noise in a case where the power value of the uplink signal is equal to or less than a first threshold.

3. The multiplexing device according to claim 2,
wherein the determination processing includes acquiring a plurality of power values of the uplink signal in a predetermined period, and updating the first threshold with the smallest power value among the acquired plurality of power values.

4. The multiplexing device according to claim 2,
wherein the first threshold differs for each radio device.

5. The multiplexing device according to claim 1,
wherein the processor is configured to perform a conversion processing that converts the uplink signals received for each radio device into a plurality of frequency components which are continuous in a frequency domain, and
wherein the calculation processing includes calculating the power value in a frequency resource unit obtained by dividing the plurality of frequency components by a predetermined number,
the determination processing includes determining whether or not the noise is dominant among the signal components in the frequency resource unit by using the power value in the frequency resource unit,
the blocking processing includes blocking the frequency resource unit where the noise is dominant in a case where the noise is determined to be dominant among the signal components in the frequency resource unit by the determination processing, and
the multiplexing processing includes multiplexing frequency components belonging to a frequency resource unit not blocked as the noise resource unit by the blocking process among the plurality of frequency components, and outputting the multiplexed component to the radio control device.

6. The multiplexing device according to claim 5,
wherein the determination processing includes determining that the noise is dominant among the signal components in the frequency resource unit in a case where the power value in the frequency resource unit is equal to or less than a second threshold.

7. The multiplexing device according to claim 6,
wherein the second threshold differs for each radio device.

8. A method for multiplexing uplink signals transmitted from each of a plurality of radio devices and outputting the multiplexed signal to a radio control device, the method comprising:
performing, by a processor, a calculation processing that calculates a power value of the uplink signal for each radio device,
performing, by the processor, a determination processing that determines whether or not noise of a radio device that transmits an uplink signal is dominant among signal components included in the uplink signal, using the power value of the uplink signal calculated by the calculation processing,
performing, by the processor, a blocking processing that blocks the uplink signal in which the noise is dominant in a case where the noise is determined to be dominant among the signal components included in the uplink signal by the determination processing, and
performing, by the processor, a multiplexing processing that multiplexes uplink signals that are not blocked by the blocking processing among the uplink signals for each radio device, and outputs the multiplexed signal to the radio control device.

9. The method according to claim 8,
wherein the determination processing includes determining that the uplink signal includes only the noise in a case where the power value of the uplink signal is equal to or less than a first threshold.

10. The method according to claim 9,
wherein the determination processing includes acquiring a plurality of power values of the uplink signal in a predetermined period, and updating the first threshold with the smallest power value among the acquired plurality of power values.

11. The method according to claim 9,
wherein the first threshold differs for each radio device.

12. The method according to claim 8, further comprising:
performing, by the processor, a conversion processing that converts the uplink signals received for each radio device into a plurality of frequency components which are continuous in a frequency domain, and
wherein the calculation processing includes calculating the power value in a frequency resource unit obtained by dividing the plurality of frequency components by a predetermined number,
the determination processing includes determining whether or not the noise is dominant among the signal components in the frequency resource unit by using the power value in the frequency resource unit,
the blocking processing includes blocking the frequency resource unit where the noise is dominant in a case where the noise is determined to be dominant among the signal components in the frequency resource unit by the determination processing, and
the multiplexing processing includes multiplexing frequency components belonging to a frequency resource unit not blocked as the noise resource unit by the blocking process among the plurality of frequency components, and outputting the multiplexed component to the radio control device.

13. The method according to claim 12,
wherein the determination processing includes determining that the noise is dominant among the signal components in the frequency resource unit in a case where the power value in the frequency resource unit is equal to or less than a second threshold.

14. The method according to claim 13,
wherein the second threshold differs for each radio device.
